(19) United States
(12) Patent Application Publication
(10) Pub. No.: US 2007/0003854 A1
(43) Pub. Date: Jan. 4, 2007

(54) Two-component developer for developing electrostatic latent image

(75) Inventor: Kenshi Matsui, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/474,411

(22) Filed: Jun. 26, 2006

(30) Foreign Application Priority Data
Jun. 30, 2005 (JP) 2005-192104

(51) Int. Cl. G03G 9/00

(52) U.S. Cl. 430/108.1

(57) ABSTRACT

In order to provide a two-component developer, which suppresses deterioration of charging performance with time of a carrier as a surface treating agent of a toner, caused by adhesion of the toner onto the surface of the carrier, and also has long lifetime and is excellent in durability, a carrier body (core particle) of which surface is porous and uneven and a porosity of 5 to 25% is used as a carrier with a silica previously adhered onto the surface of the carrier body in an amount of 1 to 10 parts by weight based on 1000 parts by weight of the carrier body.

### BACKGROUND OF THE INVENTION

1. Field of the Invention

The present invention relates to a two-component developer and, more particularly, to a two-component developer for developing an electrostatic latent image, comprising a carrier which is excellent in stability of charging performances with time.

2. Description of the Related Arts

As a carrier used in a two-component developer, a so-called coat carrier comprising a core particle and a coat layer formed on the surface of the core particle has widely been used, recently.

Document 1 (Japanese Patent No. 2,847,415) describes a carrier for electrophotographic development in which the surface of a carrier core particle is provided irregularity through corrosion with an acid or alkali and then coated with a resin.

However, there may be a risk that a surface treating agent (for example, the silica, etc.) removed from the surface of a toner may penetrate into the irregularity on the surface of the carrier core particle. Moreover, the surface treating agent penetrated into the recess portion on the surface of the carrier core particle is not scraped away by contact between the carrier core particle with each other or contact between the carrier core particle and the toner.

Therefore, as the number of an image forming treatment increases, the amount of the surface treating agent to be accumulated in the recess portion on the surface of the carrier core particle increases and the surface treating agent such as silica is a non-conductive substance, and thus charging performance of the carrier deteriorates with time. This constitutes a primary factor to cause lifetime reduction of the carrier and deterioration of durability.

### SUMMARY OF THE INVENTION

An object of the present invention is to provide a two-component developer, which suppresses deterioration of charging performance with time of a carrier such as a surface treating agent of a toner, caused by adhesion of the toner onto the surface of the carrier, and also has long lifetime and is excellent in durability.

The two-component developer of the present invention for achieving the above object is characterized by comprising a carrier and a toner, wherein the carrier contains a carrier body of which surface is porous and uneven and a silica adhered onto the surface of the carrier body, a porosity of the carrier body is 5 to 25%, and an amount of the silica adhered onto the surface of the carrier body is from 1 to 10 parts by weight based on 1000 parts by weight of the carrier body.

The two-component developer of the present invention is characterized in that the carrier body comprises a core particle of which surface is porous and uneven and a coat layer formed on the surface of the core particle.

The two-component developer of the present invention is characterized in that wherein the carrier is adjusted by mixing the carrier body of which surface is porous and uneven and a porosity of 5 to 25% with the silica in a mixer and stirring a resulting mixture in a mill to have an amount of the silica adhered on to the surface of the carrier body within a range from 1 to 10 parts by weight based on 1000 parts by weight of the carrier body.

In the present invention, a “porosity” of the carrier body refers to an area ratio (%) of a porous portion based on a cross sectional area of the carrier body determined by observing a cutting plane of the carrier body. The “cross sectional area of the carrier body” is determined as follows: assuming that the cutting plane of the carrier body has a generally circular shape (or elliptcal shape), a border line which resembles a profile of an actual carrier body is decided and then the objective cross sectional area is calculated as an area within the border line.

In the present invention, a “porosity of carrier body” is decided by the following procedure. First, a mixture of a carrier body and a proper resin is polished and a cutting plane of the carrier body, which was exposed by polishing, is observed by an optical microscope (for example, metaloscope) and the cross sectional area of the carrier body and the cross sectional area of the porous portion are measured with the measured value thus obtained, the porosity of the carrier body is calculated. Then, with respect to samples of the carrier bodies extracted at random(total number: 500 to 3000), an arithmetic average is determined from the porosity calculated individually.

In the present invention, an “amount of the silica adhered onto the surface of the carrier body” can be determined based on mixing conditions in the case of mixing the carrier body and the silica. Specifically, it can be determined by subtracting the amount of the silica removed from a mixture of the carrier body and the silica in a mill from the amount of silica when the carrier body is mixed with the silica in a mixer. The “amount of the silica adhered onto the surface of the carrier body” represents the amount of the silica adhered onto the surface of the carrier body by parts by weight based on 1000 parts by weight of the carrier body.

The “amount of the silica adhered onto the surface of the carrier body” can be determined by utilizing the fact that the carrier body and the silica differ in an X-ray intensity measured by X-ray fluorescence analysis. Namely, a calibration curve, which indicates a relation between the amounts of the carrier body and the silica and the X-ray intensity measured by X-ray fluorescence analysis, is previously made using a predetermined amount of the carrier body and the silica, and then the amount of the silica adhered onto the surface of the carrier body can be determined by using this calibration curve. In this case, regardless of the mixing conditions of the carrier body and the silica in the case of mixing them, the amount of the silica adhered onto the surface of the carrier body can be determined.

In the carrier, a silica is previously adhered onto the surface of a carrier body of which surface is porous and uneven and, as a result, a recess portion on the surface of the carrier body is filled (embedded) with a predetermined amount of the silica. Therefore, when an image forming treatment is repeated using a two-component developer comprising a carrier and a toner, it is possible to suppress the amount of the silica adhered additionally onto the surface of the carrier (particularly, the amount of the silica with which the recess portion of the carrier body is filled).

Thus, according to the two-component developer comprising the carrier of the present invention, it is possible to prevent occurrence of a large difference between a charging performance at the initial stage when an image forming treatment is carried out using this two-component developer, and a charging performance after the image forming treatment is repeatedly carried out, and thus attaining a stable charging performance for a long period.

### DESCRIPTION OF PREFERRED EMBODIMENTS

The two-component developer of the present invention comprises a carrier and a toner and the carrier comprises a carrier body (core particle) of which surface is porous and uneven and a silica adhered onto the surface of the carrier body.

The carrier body is not specifically limited, except that it is a porous material having irregularity (unevenness) on the surface and has a porosity of 5 to 25%.

Examples of the material of the carrier body include magnetic materials such as ferrite (sintered ferrite), magnetite, lithium, manganese and iron powder, of which ferrite is particularly preferable.

The porosity of the carrier body is from 5 to 25%, preferably from 10 to 25%, and more preferably from 10 to 20%.

If the porosity of the carrier body is less than the above range, the amount of the silicathe the silica adhered stably onto the carrier body decreases, then it becomes impossible to attain stability with time with respect to charging performance of the carrier. Moreover, if the porosity of the carrier body is less than the above range, since adhesion between the carrier body and a coat layer described hereinafter decreases, the coat layer is likely to be removed with time. This fact exerts an adverse influence in view of stability of charging performance with time, as described above. If the porosity of the carrier body is less than the above range, when the image forming treatment is repeated, a decrease in charge amount and an increase in fog density drastically occur.

On the other hand, if the porosity of the carrier body is more than the above range, a degree of irregularity on the surface of the carrier body becomes drastic and a large number of the recess portions capable of being filled (embedded) with the silica are formed on the surface of the carrier body. As a result, since the amount of the silica adhered stably onto the surface of the carrier body increases too much, thereby an electrical resistance of the carrier excessively increases and charging performance deteriorates. If the porosity of the carrier body is more than the above range, when the image forming treatment is repeated, charge-up is likely to occur and it becomes impossible to obtain a sufficient image density (thus causing a decrease in image density (ID)).

A primary particle size of the carrier body is appropriately set according to a particle size of the toner in the two-component developer and charging performance of the carrier body and therefore it is not specifically limited. In general, an average particle size, which is determined by an apparatus for measuring particle size distribution (for example, an accurate particle sizing and counting analyzer “Multisizer” series manufactured by Beckman Coulter Inc.) based on The Coulter Principle in a state before a silica is adhered onto the surface of the carrier body and the state before a coat layer described hereinafter is formed on the surface of the carrier body, is preferably from 30 to 100 μm, and more preferably from 35 to 60 μm.

The amount of the silica adhered onto the surface of the carrier body (the amount of silica with which the recess portion on the surface of the carrier body is filled) is from 1 to 10 parts by weight, preferably from 2 to 8 parts by weight, and more preferably from 3 to 6 parts by weight, based on 1000 parts by weight of the carrier body.

If the amount of the silica adhered onto the surface of the carrier body is less than the above range, it becomes impossible to attain stability with time with respect to charging performance of the carrier. If the amount of the silica adhered is less than the above range, when a charging characteristic of the toner is adjusted to slightly poor extent in anticipation of deterioration of charging performance of the carrier caused by repetition of the image forming treatment, since the charging performance of the toner become excessively high at the initial stage of the image forming treatment, it becomes impossible to obtain a sufficient image density (a image density (ID) decreases). On the other hand, if the amount of the silica adhered is less than the above range, when a charging characteristic of the toner is adjusted according to a charging performance of the carrier at the initial stage of the image forming treatment, the charging performance of the carrier is drastically deteriorated by repetition of the image forming treatment, and thus a decrease in charge amount and an increase in fog density drastically occur when the image forming treatment is repeated.

On the other hand, if the amount of the silica adhered onto the surface of the carrier body is more than the above range, a decrease in charge amount and an increase in fog density drastically occur when the image forming treatment is repeated.

The method for producing the carrier body will now be described with reference to the method in which the carrier body is made of a ferrite particle (ferrite carrier) as an example.

First, Fe₂O₃ and MO (M=Mn²⁺, Co²⁺, Ni²⁺, Cu²⁺, Zn²⁺, etc.) as raw materials are preliminary fired, charged in water, finely ground by a ball mill and then mixed with polyvinyl alcohol as a binder, a defoamer, a dispersing agent and other known additives to prepare a slurry for granulation. Since the binder, the defoamer, the dispersing agent and other known additives are scattered as a result of decomposition or while firing the ferrite particles described hereinafter, there is selected a material which does not exert an adverse influence while the process for production of the ferrite carrier.

Then, the ferrite particle is granulated while drying the slurry for granulation under heat using a spray drier. The granulated ferrite particle is spherical and is generally referred to as a granule. The resulting ferrite particle (granule) are filled into an alumina vessel and then fired.

For firing of the ferrite particle, a tunnel type electric furnace is commonly used. A firing temperature is preferably from about 500 to 1400° C., and more preferably from about 800 to 1000° C., and a firing time is preferably from 2 to 30 hours, and more preferably from 4 to 12 hours. Through this firing process, a ferrite as a carrier body (core particle) is obtained by a solid phase chemical reaction.

To control electrical resistance of the carrier body, the ferrite particle may be cooled in an N₂ atmosphere after firing.

When the carrier body is made of a magnetite particle, it can be produced in the same manner as in the above-mentioned method for producing a ferrite particle.

The porosity of the carrier body can be appropriately adjusted by varying the firing temperature when the carrier body is made of a ferrite particle or a magnetite particle. In general, as the firing temperature becomes higher, the surface of the carrier body becomes smooth and the porosity decreases. On the other hand, as the firing temperature becomes lower, irregularity on the surface of the carrier increases furthermore and the porosity increases.

The porosity of the carrier body can also be appropriately adjusted by subjecting the carrier body to a physical and mechanical treatment thereby to form a depression (recess portion) on the surface of the carrier body. Examples of the physical and mechanical treatment to the carrier body include a treatment in which the carrier body is stirred and ground in a mill such as a ball mill.

The carrier body has a depressed portion (recess portion) formed due to a pore in the carrier body on the surface thereof. An average circularity of the carrier body is not specifically limited and is preferably from 0.830 to 0.950, and more preferably from 0.85 to 0.93.

The circularity of the carrier body is calculated based on the analysis results of images of the carrier body using an image analysis means such as a flow type particle image analyzer. The circularity of the carrier body is determined as follows. A circle having the same area as that of a projection plane of one carrier body appeared on an images to be analyzed and then a circumference of the circle is divided by that of the projection plane. As the circularity of a non-magnetic toner approaches 1, irregularity on the surface of the carrier body decreases and the shape approaches a perfect sphere. On the other hand, as the circularity decreases below 1, irregularity on the surface of the carrier body increases. The average circularity of the carrier body is an arithmetic average of circularities calculated with respect to samples of the carrier bodies extracted at random (total number: 500 to 3000).

The carrier body may further comprise a coat layer formed on the surface thereof.

Examples of the resin material which forms the coat layer include, but are not limited to, a silicone resin, a fluororesin, an acrylic resin, a styrene-based resin, a silicone-based resin and an epoxy-based resin. The coat layer is preferably made of a material capable of suppressing adhesion onto the surface of the carrier such as a surface treating agent (for example, silica, etc.) of the toner, or a fine powdered toner. Therefore, a material having a small surface tension is preferable among these resin materials and, for example, a silicone resin and a fluororesin are preferable.

The method for forming the coat layer is not specifically limited and a known method can be appropriately selected. A thickness of the coat layer may be appropriately set according to a material of the carrier body and a charging performance required to the carrier and is not specifically limited, but is preferably from 0.2 to 5 μm, and more preferably from 0.5 to 2 μm.

A silica to be adhered onto the surface of the carrier body is not specifically limited and a silica in the form of fine powders used as a surface treating agent of a toner can be commonly used.

A primary particle size of the silica is not specifically limited and is preferably from 0.1 to 100 nm, and more preferably from 1 to 50 nm, in terms of a volume average particle size.

If the primary particle size of the silica is more than the above range, there may be a risk that it becomes impossible to sufficiently adhere the silica onto the surface of the carrier (it becomes impossible to sufficiently fill the silica into the recess portion of the carrier body). On the other hand, a silica having the primary particle size less than the above range is hardly available in general and, when the silica having a primary particle size of less than the above range is used, there may be a risk that it becomes difficult to remove the silica adhered excessively onto the carrier.

The carrier in the two-component developer of the present invention wherein the carrier is adjusted by mixing the carrier body of which surface is porous and uneven and a porosity of 5 to 25% with the silica in a mixer and stirring a resulting mixture in a mill to have an amount of the silica adhered on to the surface of the carrier body within a range from 1 to 10 parts by weight based on 1000 parts by weight of the carrier body.

The silica can be adhered to the entire surface of the carrier body by mixing the carrier body and the silica in a mixer. Furthermore, the silica adhered excessively onto the surface of the carrier body can be removed by stirring the resulting mixture of the carrier body and the silica in a mill.

A mixing ratio of the carrier body to the silica may be set so that an amount of the silica adhered onto the surface of the carrier body (amount of the silica filled into the recess portion on the surface of the carrier body) satisfies the above range. For example, in the two-component developer of the present invention, as described above, the carrier body is mixed with the silica and then the resulting mixture is stirred in a mill and the silica adhered excessively onto the surface of the carrier body is removed, and therefore the amount of the silica is set to a value which is slightly larger than that of the silica adhered onto the surface of the carrier body (for example, about 2 to 5 parts by weight based on 1000 parts by weight of the carrier body).

Examples of the mixer include a Henschel mixer and a rocking mixer. The conditions of the mixing treatment using the mixer are set according to the amounts of the carrier body and the silica and are not specifically limited. For example, a mixing time in the Henschel mixer is preferably from 0.5 to 10 hours, and more preferably from 0.1 to 3 hours.

In order to remove the silica adhered excessively from the surface of the carrier body after adhering the silica onto the surface of the carrier body, for example, the mixture of the carrier body and the silica subjected to a mixing treatment in a mixer may be charged in a mill and then stirred, thereby to repeat contact between the carrier body and the wall of the mill.

Examples of the mill include a ball mill and a tubular mixer. The conditions of the stirring treatment by the mill are set according to the amount of a mixture of the carrier body and the silica to be charged and are not specifically limited. For example, a mixing time in the ball mill is preferably from 0.1 to 5 hours, and more preferably from 0.3 to 3 hours.

The two-component developer of the present invention is produced by mixing the carrier body and the silica in a mixer, and stirring the resulting mixture in a mill to adjust an amount of the silica adhered on to the surface of the carrier body within a range from 1 to 10 parts by weight based on 1000 parts by weight of the carrier body. Then, the carrier thus obtained and a toner are prepared and mixed to produce the two-component developer.

For preparing and stirring the carrier and the toner, a mixer may be used. As a mixer, for example, those same as the mixers above may be mentioned.

Since a content ratio of the toner (toner concentration) in the two-component developer is appropriately set according to a required toner concentration for the two-component developer, the content ratio is not specifically limited. Usually, a content ratio of the toner in the two-component developer is preferably 3 to 30, more preferably 5 to 15.

In the present invention, the toner is not specifically limited and various toners used in the two-component developer can be used. Specific examples thereof include those comprising a toner particle and a surface treating agent adhered onto the surface of the toner particles.

The toner particle may be obtained by adding a colorant in a binder resin, optionally adding a charge control agent and a wax, and grinding the resulting melt-kneaded mixture of these components to form a particle. Also the toner particle may be obtained by optionally adding a charge control agent and a wax to a mixture of a monomer component, which forms a binder resin, and a colorant, and forming the mixture into a particle using a polymerization method such as a suspension polymerization method.

Examples of the surface treating agent include those which are adhered onto the surface of the toner particle for the purpose of improving fluidity of the toner, for example, silica, titanium oxide and alumina in the form of a fine particle. These surface treating agents can be appropriately selected and added to the toner particle according to a conventional method.

In general, a carrier contained in a two-component developer, which is contained in a developing device of an image forming apparatus, is coated and contaminated with time with a surface treating agent for a toner such as silica by an operation of an apparatus for image forming treatment. As a result, a charging performance of the carrier deteriorates with time to cause a problem such as an increase in fog density. However, regarding the carrier contained in the two-component developer of the present invention, as described above, a silica is previously adhered onto the surface of the carrier body (the recess portion on the surface of the carrier body is filled with the silica), that is, the carrier body is contaminated with the silica to some extent. Therefore, the amount of silica adhered onto the surface of the carrier does not vary drastically even by the operation of the apparatus for image forming treatment. Thus, according to the charging performance of the carrier in the state where the recess portion on the surface of the carrier body is previously filled with the silica, a stable charging performance of the carrier can be obtained by appropriately setting a charging performance of the toner and a development conditions such as developing bias voltage, regardless of the number of the image forming treatment.

### EXAMPLES

The present invention will now be described by way of Examples and Comparative Examples, but the present invention is not limited by the following Examples.

### Example 1

(Production of Two-Component Developer)

A raw material of a ferrite particle was fired in an atmosphere of oxygen having a predetermined concentration at a predetermined firing temperature to obtain a core particle (ferrite core) having a recess portion on the surface (average particle size: 60 μm, saturation magnetization: 60 emu/g). Furthermore, the resulting core particle was coated with a silicone resin (manufactured by SHIN-ETSU CHEMICAL CO., LTD. under the trade name of “KR271”) by a spray dry method to obtain a carrier body comprising a core particle having a recess portion on a surface and a coat layer formed on the surface of the core particle. The coat layer had a thickness of about 1.0 μm.

A mixture obtained by mixing the carrier body with a resin was polished and a cutting plane of the carrier body exposed by polishing was observed by a metaloscope, and then a cross sectional area of the carrier body and a cross sectional area of a porous portion were measured using an image analyzer (manufactured by Nippon Avionics Co., Ltd. under the trade name of “TVIP-4100”). Furthermore, a porosity (%) of the carrier body was calculated from the resulting measured value. As a result, it was 5%.

Then, 1000 parts by weight of the carrier body was mixed with 3.0 parts by weight of a silica (manufactured by NIPPON AEROSIL CO., LTD. under the trade name of “REA-200”, average particle size: 13 nm) in a Henschel mixer and the resulting mixture was charged in a ball mill (more specifically, each 50 g of a carrier was charged in a vessel having a volume of 500 mL), was stirred at 100 rpm for 30 minutes. Contact between the surface of the carrier and the wall surface of the ball mill was repeatedly conducted and excessive the silica adhered on the carrier body was removed by this stirring operation to obtain a carrier. It was confirmed by an image analyzer that the amount of the silica adhered onto the surface of the carrier was 1.0 parts by weight based on 1000 parts by weight of the carrier body and that the silica was adhered onto the surface of the carrier body.

Then, the carrier thus obtained was mixed with a toner particle (binder resin: polyester, average particle size: 8 μm) in a weight ratio of 100:6 to obtain a two-component developer.

(Image Forming Treatment Test)

Using the above two-component developer, an image forming treatment test of a character original was conducted at a printing rate of 5% by an image forming apparatus (electrophotographic copier, model number “FS-3500”, manufactured by KYOCERA MITA Corp.). An electrophotographic copier comprises an amorphous silicone drum as a photoconductor drum.

(Evaluation of Formed Images)

At the initial stage of the image forming treatment test and after printing of 30000 copies in the image forming treatment test, an image density ID of formed images and a fog density FD of a blank portion were measured using a reflection densitometer (article number “TC-6D”, manufactured by Tokyo Denshoku CO., LTD.) and an average value was found.

The image density ID was found to be 1.20 or more and the fog density FD was found to be 0.008 or less.

(Measurement of Charge Amount of Carrier)

A charge amount (μC/g) of a carrier shows a charge amount per unit weight of the carrier. At the initial stage of the image forming treatment test and after printing of 30000 copies in the image forming treatment test, 200 mg of the carrier collected and fractionated from a developer vessel of an image forming apparatus was filled into an apparatus for measuring a blow-off charge amount (model number “TB-200”, manufactured by KYOCERA Chemical Corporation) under a blow condition of a blow pressure of about 9.81 N (1 kgf) for 20 seconds.

### Examples 2 to 3 and Comparative Examples 1 to 2

In the same manner as in Example 1, except that the amount of the silica adhered was appropriately adjusted by varying the amount (charge amount) of the silica in the case of mixing the carrier body with the silica, a carrier was obtained, respectively.

The amount (charge amount) of the silica was adjusted to 8.0 parts by weight (Example 2), 13.0 parts by weight (Example 3), 2 parts by weight (Comparative Example 1) and 15.0 parts by weight (Comparative Example 2) based on 1000 parts by weight of the carrier body, respectively. As a result, the amount of the silica adhered was found to be 5.0 parts by weight (Example 2), 10.0 parts by weight (Example 3), 0.8 parts by weight (Comparative Example 1) and 12.0 parts by weight (Comparative Example 2) based on 1000 parts by weight of the carrier body, respectively.

In the same manner as in Example 1, except that the resulting carrier was used, a two-component developer was produced and an image forming treatment was conducted, and then a formed image was evaluated and a charge amount of the carrier was measured, respectively.

### Example 4

In the same manner as in Example 1, except that the firing temperature of the ferrite particle and the oxygen concentration of the atmosphere while firing were varied, a core particle having a recess portion on a surface was obtained. In the same manner as in Example 1, except that the resulting core particle was used, a carrier body, a carrier and a two-component developer were produced. In the same manner as in Example 1, an image forming treatment test was conducted, and then formed images were evaluated and a charge amount of the carrier was measured. As a result, the carrier body had a porosity of 10%.

### Example 5 to 6 and Comparative Examples 3 to 4

In the same manner as in Example 4, except that the amount of the silica adhered was appropriately adjusted by varying the amount (charge amount) of the silica in the case of mixing the carrier body with the silica, a carrier was obtained, respectively. The amount of the silica adhered was 5.0 parts by weight (Example 5), 10.0 parts by weight (Example 6), 0.8 parts by weight (Comparative Example 3) and 12.0 parts by weight (Comparative Example 4) based on 1000 parts by weight of the carrier body, respectively. In the same manner as in Example 1, except that the resulting carrier was used, a two-component developer was produced and an image forming treatment test was conducted, and then a formed image was evaluated and the charge amount of the carrier was measured, respectively.

### Example 7

In the same manner as in Example 1, except that the firing temperature of the ferrite particle and the oxygen concentration of the atmosphere while firing were varied, a core particle having a recess portion on a surface was obtained. In the same manner as in Example 1, except that the resulting core particle was used, a carrier body, a carrier and a two-component developer were produced. In the same manner as in Example 1, an image forming treatment test was conducted, and then a formed image was evaluated and a charge amount of the carrier was measured. The carrier body had a porosity of 25%.

### Examples 8 to 9 and Comparative Examples 5 to 6

In the same manner as in Example 7, except that the amount of the silica adhered was appropriately adjusted by varying the amount (charge amount) of silica in the case of mixing the carrier body with the silica, a carrier was obtained, respectively. The amount of the silica adhered was 5.0 parts by weight (Example 8), 10.0 parts by weight (Example 9), 0.8 parts by weight (Comparative Example 5) and 12.0 parts by weight (Comparative Example 6) based on 1000 parts by weight of the carrier body, respectively. In the same manner as in Example 1, except that the resulting carrier was used, a two-component developer was produced and an image forming treatment test was conducted, and then a formed image was evaluated and the charge amount of the carrier was measured, respectively.

### Comparative Examples 7 and 8

In the same manner as in Example 1, except that the firing temperature of the ferrite particle and the oxygen concentration of the atmosphere while firing were varied, a core particle having a recess portion on the surface was obtained, respectively. In the same manner as in Example 1, except that the resulting core particle was used, a carrier body, a carrier and a two-component developer were produced, respectively. In the same manner as in Example 1, an image forming treatment test was conducted, and then a formed image was evaluated and a charge amount of the carrier was measured, respectively. The carrier body had a porosity of 3% (Comparative Example 7) and 30% (Comparative Example 8), respectively.

### Comparative Examples 9 and 10

In the same manner as in Example 2, except that the firing temperature of the ferrite particle and the oxygen concentration of the atmosphere while firing were varied, core particle having a recess portion on the surface was obtained, respectively. In the same manner as in Example 2, except that the resulting core particle was used, a carrier body, a carrier and a two-component developer were produced, respectively. In the same manner as in Example 1, an image forming treatment test was conducted, and then formed image was evaluated and a charge amount of the carrier was measured, respectively. The carrier body had a porosity of 3% (Comparative Example 9) and 30% (Comparative Example 10), respectively.

### Comparative Example 11 and 12

In the same manner as in Example 3, except that the firing temperature of the ferrite particle and the oxygen concentration of the atmosphere while firing were varied, a core particle having a recess portion on the surface was obtained, respectively. In the same manner as in Example 3, except that the resulting core particle was used, a carrier body, a carrier and a two-component developer were produced, respectively. In the same manner as in Example 1, an image forming treatment test was conducted, and then formed image was evaluated and a charge amount of the carrier was measured, respectively. The carrier body had a porosity of 3% (Comparative Example 11) and 30% (Comparative Example 12), respectively.

With respect to Examples 1 to 9 and Comparative Examples 1 to 12, the kind of the coat layer, the porosity (%) of the carrier body, the amount (parts by weight) of silica adhered, the evaluation result of the formed images in the image forming treatment test and the charge amount (pC/g) of the carrier are shown in Tables 1 to 6.

TABLE 1

| | Comparative | Examples | | | Comparative |
|---|---|---|---|---|---|
| | Example 1 | 1 | 2 | 3 | Example 2 |
| Kind of coat layer | Si | Si | Si | Si | Si |
| Porosity of carrier body (%) | 5 | 5 | 5 | 5 | 5 |
| Amount of the silica adhered | 0.8 | 1.0 | 5.0 | 10.0 | 12.0 |
| (Parts by weight) | | | | | |
| Image formation treatment, initial | | | | | |
| stage | | | | | |
| Image density ID | 1.299 | 1.411 | 1.408 | 1.419 | 1.423 |
| Evaluation results | Good | Good | Good | Good | Good |
| Fog density FD | 0.002 | 0.002 | 0.002 | 0.002 | 0.002 |
| Evaluation results | Good | Good | Good | Good | Good |
| Charge amount (μC/g) | 25.2 | 17.1 | 16.5 | 14.8 | 18.1 |
| Evaluation results | High | Good | Good | Good | Good |
| Image formation treatment, after | | | | | |
| printing of 30000 copies | | | | | |
| Image density ID | 1.465 | 1.399 | 1.403 | 1.399 | 1.508 |
| Evaluation results | Good | Good | Good | Good | Good |
| Fog density FD | 0.002 | 0.001 | 0.003 | 0.002 | 0.010 |
| Evaluation results | Good | Good | Good | Good | High |
| Charge amount (μC/g) | 15.6 | 16.8 | 15.9 | 14.7 | 10.8 |
| Evaluation results | Good | Good | Good | Good | Low |

TABLE 2

| | Comparative | Examples | | | Comparative |
|---|---|---|---|---|---|
| | Example 3 | 4 | 5 | 6 | Example 4 |
| Kind of coat layer | Si | Si | Si | Si | Si |
| Porosity of carrier body (%) | 10 | 10 | 10 | 10 | 10 |
| Amount of the silica adhered | 0.8 | 1.0 | 5.0 | 10.0 | 12.0 |
| (Parts by weight) | | | | | |
| Image formation treatment, initial | | | | | |
| stage | | | | | |
| Image density ID | 1.233 | 1.429 | 1.432 | 1.412 | 1.413 |
| Evaluation results | Good | Good | Good | Good | Good |
| Fog density FD | 0.003 | 0.001 | 0.005 | 0.002 | 0.001 |
| Evaluation results | Good | Good | Good | Good | Good |
| Charge amount (μC/g) | 23.8 | 17.3 | 16.1 | 15.2 | 15.9 |
| Evaluation results | High | Good | Good | Good | Good |
| Image formation treatment, after | | | | | |
| printing of 30000 copies | | | | | |
| Image density ID | 1.455 | 1.419 | 1.421 | 1.400 | 1.535 |
| Evaluation results | Good | Good | Good | Good | Good |
| Fog density FD | 0.001 | 0.002 | 0.003 | 0.003 | 0.019 |
| Evaluation results | Good | Good | Good | Good | High |
| Charge amount (μC/g) | 15.6 | 17.4 | 15.8 | 14.8 | 6.5 |
| Evaluation results | Good | Good | Good | Good | Low |

TABLE 3

| | Comparative | Examples | | | Comparative |
|---|---|---|---|---|---|
| | Example 5 | 7 | 8 | 9 | Example 6 |
| Kind of coat layer | Si | Si | Si | Si | Si |
| Porosity of carrier body (%) | 25 | 25 | 25 | 25 | 25 |
| Amount of the silica adhered | 0.8 | 1.0 | 5.0 | 10.0 | 12.0 |
| (Parts by weight) | | | | | |
| Image formation treatment, initial | | | | | |
| stage | | | | | |
| Image density ID | 1.255 | 1.403 | 1.411 | 1.423 | 1.418 |
| Evaluation results | Good | Good | Good | Good | Good |
| Fog density FD | 0.001 | 0.002 | 0.002 | 0.001 | 0.005 |
| Evaluation results | Good | Good | Good | Good | Good |
| Charge amount (μC/g) | 24.3 | 17.8 | 16.3 | 16.3 | 15.6 |
| Evaluation results | High | Good | Good | Good | Good |
| Image formation treatment, after | | | | | |
| printing of 30000 copies | | | | | |
| Image density ID | 1.411 | 1.421 | 1.421 | 1.411 | 1.489 |
| Evaluation results | Good | Good | Good | Good | Good |
| Fog density FD | 0.003 | 0.001 | 0.002 | 0.001 | 0.010 |
| Evaluation results | Good | Good | Good | Good | High |
| Charge amount (μC/g) | 16.5 | 17.6 | 15.9 | 14.9 | 10.1 |
| Evaluation results | Good | Good | Good | Good | Low |

TABLE 4

| | Comparative | Examples | | | Comparative |
|---|---|---|---|---|---|
| | Example 7 | 1 | 4 | 7 | Example 8 |
| Kind of coat layer | Si | Si | Si | Si | Si |
| Porosity of carrier body (%) | 3 | 5 | 10 | 25 | 30 |
| Amount of the silica adhered | 1.0 | 1.0 | 1.0 | 1.0 | 1.0 |
| (Parts by weight) | | | | | |
| Image formation treatment, initial | | | | | |
| stage | | | | | |
| Image density ID | 1.423 | 1.411 | 1.429 | 1.403 | 1.410 |
| Evaluation results | Good | Good | Good | Good | Good |
| Fog density FD | 0.001 | 0.002 | 0.001 | 0.002 | 0.002 |
| Evaluation results | Good | Good | Good | Good | Good |
| Charge amount (μC/g) | 15.9 | 17.1 | 17.3 | 17.8 | 16.2 |
| Evaluation results | Good | Good | Good | Good | Good |
| Image formation treatment, after | | | | | |
| printing of 30000 copies | | | | | |
| Image density ID | 1.566 | 1.399 | 1.419 | 1.421 | 1.199 |
| Evaluation results | Good | Good | Good | Good | Low |
| Fog density FD | 0.018 | 0.001 | 0.002 | 0.001 | 0.001 |
| Evaluation results | High | Good | Good | Good | Good |
| Charge amount (μC/g) | 7.8 | 16.8 | 17.4 | 17.6 | 25.3 |
| Evaluation results | Low | Good | Good | Good | High |

TABLE 5

| | Comparative | Examples | | | Comparative |
|---|---|---|---|---|---|
| | Example 9 | 2 | 5 | 8 | Example 10 |
| Kind of coat layer | Si | Si | Si | Si | Si |
| Porosity of carrier body (%) | 3 | 5 | 10 | 25 | 30 |
| Amount of the silica adhered | 5.0 | 5.0 | 5.0 | 5.0 | 5.0 |
| (Parts by weight) | | | | | |
| Image formation treatment, initial | | | | | |
| stage | | | | | |
| Image density ID | 1.408 | 1.408 | 1.432 | 1.411 | 1.425 |
| Evaluation results | Good | Good | Good | Good | Good |
| Fog density FD | 0.005 | 0.002 | 0.005 | 0.002 | 0.001 |
| Evaluation results | Good | Good | Good | Good | Good |
| Charge amount (μC/g) | 16.5 | 16.5 | 16.1 | 16.3 | 17.1 |
| Evaluation results | Good | Good | Good | Good | Good |
| Image formation treatment, after | | | | | |
| printing of 30000 copies | | | | | |
| Image density ID | 1.542 | 1.403 | 1.421 | 1.421 | 1.235 |
| Evaluation results | Good | Good | Good | Good | Good |
| Fog density FD | 0.012 | 0.003 | 0.003 | 0.002 | 0.002 |
| Evaluation results | High | Good | Good | Good | Good |
| Charge amount (μC/g) | 10.8 | 15.9 | 15.8 | 15.9 | 24.1 |
| Evaluation results | Low | Good | Good | Good | High |

TABLE 6

| | Comparative | Examples | | | Comparative |
|---|---|---|---|---|---|
| | Example 11 | 3 | 6 | 9 | Example 12 |
| Kind of coat layer | Si | Si | Si | Si | Si |
| Porosity of carrier body (%) | 3 | 35 | 310 | 325 | 330 |
| Amount of the silica adhered | 10.0 | 10.0 | 10.0 | 10.0 | 10.0 |
| (Parts by weight) | | | | | |
| Image formation treatment, initial | | | | | |
| stage | | | | | |
| Image density ID | 1.423 | 1.419 | 1.412 | 1.423 | 1.411 |
| Evaluation results | Good | Good | Good | Good | Good |
| Fog density FD | 30.002 | 30.002 | 30.002 | 30.001 | 30.004 |
| Evaluation results | Good | Good | Good | Good | Good |
| Charge amount (μC/g) | 316.5 | 314.8 | 315.2 | 316.3 | 317.5 |
| Evaluation results | Good | Good | Good | Good | Good |
| Image formation treatment, after | | | | | |
| printing of 30000 copies | | | | | |
| Image density ID | 31.561 | 31.399 | 31.400 | 31.411 | 31.222 |
| Evaluation results | Good | Good | Good | Good | Good |
| Fog density FD | 30.013 | 30.002 | 30.003 | 30.001 | 30.001 |
| Evaluation results | High | Good | Good | Good | Good |
| Charge amount (μC/g) | 310.8 | 14.7 | 14.8 | 14.9 | 23.3 |
| Evaluation results | Low | Good | Good | Good | High |

In Tables 1 to 6, “Si” in the column of the “kind of coat resin” means a silicone resin. “Amount of the silica adhered” means the amount adhered (parts by weight) based on 1000 parts by weight of the carrier body.

As is apparent from Tables 1 to 6, Examples 1 to 9 using a carrier body coated with silica adhered on the surface having a porosity of 5 to 25%, the amount of the silica adhered being from 1 to 10 parts by weight based on 1000 parts by weight of the carrier body, could adjust the results of the image density, fog density and charge amount within a proper range even after repetition of printing 30,000 copies in the image forming treatment.

### Example 10

(Production of Two-Component Developer)

The same core particle (ferrite core) as those used in Example 1 were coated with a fluororesin (manufactured by Ausimont Co. under the trade name of “HYLAR301F”) by a spray dry method to obtain a carrier body comprising a core particle having a recess portion on the surface and a coat layer formed on the surface of the core particle. The coat layer had a thickness of about 1 μm. In the same manner as in Example 1, a porosity (%) of the carrier body was calculated. As a result, it was 5%.

Then, 1000 parts by weight of the carrier body was mixed with 3 parts by weight of the silica (aforementioned “REA-200”) using a Henschel mixer and the resulting mixture was charged in a ball mill, followed by stirring for 30 minutes in the same manner as in Example 1. Contact between the surface of the carrier and the wall surface of the ball mill was repeatedly conducted and excessive silica adhered on the carrier body was removed by this stirring operation to obtain a carrier. For the carrier thus obtained, the amount of silica adhered onto the surface of the carrier was 1.0 parts by weight based on 1000 parts by weight of the carrier body.

Then, the carrier thus obtained was mixed with a toner particle (binder resin: polyester, average particle size: 8 μm) in a weight ratio of 100:6 to obtain a two-component developer.

(Image Forming Treatment Test, Evaluation of Formed Image and Measurement of Charge Amount of Carrier)

In the same manner as in Example 1, except that the two-component developer was used, an image forming treatment test was conducted, and then a formed image was evaluated and a charge amount of the carrier was measured.

### Examples 11 to 12 and Comparative Examples 13 to 14

In the same manner as in Example 10, except that the amount of the silica adhered was appropriately adjusted by varying the amount (charge amount) of silica in the case of mixing the carrier body with the silica, a carrier was obtained, respectively. The amount of the silica adhered were respectively 5.0 parts by weight (Example 11), 10.0 parts by weight (Example 12), 0.8 parts by weight (Comparative Example 13) and 12.0 parts by weight (Comparative Example 14) based on 1000 parts by weight of the carrier body, respectively.

In the same manner as in Example 10, except that the resulting carrier was used, a two-component developer was produced and an image forming treatment test was conducted, and then a formed image was evaluated and a charge amount of the carrier was measured.

### Example 13

In the same manner as in Example 10, except that the firing temperature of the ferrite particle and the oxygen concentration of the atmosphere while firing were varied, a core particle having a recess portion on the surface was obtained. In the same manner as in Example 10, except that the resulting core particle was used, a carrier body, a carrier and a two-component developer were produced. In the same manner as in Example 10, an image forming treatment test was conducted, and then a formed image was evaluated and a charge amount of the carrier was measured. The carrier body had a porosity of 10%.

### Examples 14 to 15 and Comparative Examples 15 to 16

In the same manner as in Example 13, except that the amount of the silica adhered was appropriately adjusted by varying the amount (charge amount) of the silica in the case of mixing the carrier body with the silica, a carrier was obtained, respectively. The amounts of the silica adhered were 5.0 parts by weight (Example 14), 10.0 parts by weight (Example 15), 0.8 parts by weight (Comparative Example 15) and 12.0 parts by weight (Comparative Example 16) based on 1000 parts by weight of the carrier body, respectively. In the same manner as in Example 10, except that the resulting carrier was used, a two-component developer was produced and an image forming treatment test was conducted, and then a formed image was evaluated and a charge amount of the carrier was measured, respectively.

### Example 16

In the same manner as in Example 10, except that the firing temperature of the ferrite particle and the oxygen concentration of the atmosphere while firing were varied, a core particle having a recess portion on the surface was obtained. In the same manner as in Example 10, except that the resulting core particle was used, a carrier body, a carrier and a two-component developer were produced. In the same manner as in Example 10, an image forming treatment test was conducted, and then a formed image was evaluated and a charge amount of the carrier was measured. The carrier body had a porosity of 25%.

### Examples 17 to 18 and Comparative Examples 17 to 18

In the same manner as in Example 16, except that the amount of the silica adhered was appropriately adjusted by varying the amount (charge amount) of silica in the case of mixing the carrier body with the silica, a carrier was obtained, respectively. The amount of the silica adhered was 5.0 parts by weight (Example 17), 10.0 parts by weight (Example 18), 0.8 parts by weight (Comparative Example 17) and 12.0 parts by weight (Comparative Example 18) based on 1000 parts by weight of the carrier body, respectively. In the same manner as in Example 10, except that the resulting carrier was used, a two-component developer was produced and an image forming treatment test was conducted, and then a formed image was evaluated and a charge amount of the carrier was measured, respectively.

### Comparative Example 19 and 20

In the same manner as in Example 10, except that the firing temperature of the ferrite particle and the oxygen concentration of the atmosphere while firing were varied, a core particle having a recess portion on the surface was obtained, respectively. In the same manner as in Example 10, except that the resulting core particle was used, a carrier body, a carrier and a two-component developer were produced, respectively. In the same manner as in Example 10, an image forming treatment test was conducted, and then a formed image was evaluated and the charge amount of the carrier was measured, respectively. The carrier body had a porosity of 3% (Comparative Example 19) and 30% (Comparative Example 20), respectively.

### Comparative Example 21 and 22

In the same manner as in Example 11, except that the firing temperature of the ferrite particle and the oxygen concentration of the atmosphere while firing were varied, a core particle having a recess portion on the surface was obtained. In the same manner as in Example 11, except that the resulting core particle was used, a carrier body, a carrier and a two-component developer were produced, respectively. In the same manner as in Example 10, an image forming treatment test was conducted, and then a formed image was evaluated and the charge amount of the carrier was measured, respectively. The carrier body had a porosity of 3% (Comparative Example 21) and 30% (Comparative Example 22), respectively.

### Comparative Example 23 and 24

In the same manner as in Example 12, except that the firing temperature of the ferrite particles and the oxygen concentration of the atmosphere while firing were varied, a core particle having a recess portion on the surface was obtained. In the same manner as in Example 12, except that the resulting core particle was used, a carrier body, a carrier and a two-component developer were produced, respectively. In the same manner as in Example 10, an image forming treatment test was conducted, and then a formed image was evaluated and a charge amount of the carrier was measured, respectively. The carrier body had a porosity of 3% (Comparative Example 23) and 30% (Comparative Example 24), respectively.

With respect to Examples 10 to 18 and Comparative Examples 13 to 24, the kind of the coat layer, the porosity (%) of the carrier body, the amount (parts by weight) of silica adhered, the evaluation result of the formed image in the image forming treatment test and the charge amount (μC/g) of the carrier are shown in Tables 7 to 12.

TABLE 7

| | Comparative | Examples | | | Comparative |
|---|---|---|---|---|---|
| | Example 13 | 10 | 11 | 12 | Example 14 |
| Kind of coat layer | F | F | F | F | F |
| Porosity of carrier body (%) | 5 | 5 | 5 | 5 | 5 |
| Amount of the silica adhered | 0.8 | 1.0 | 5.0 | 10.0 | 12.0 |
| (Parts by weight) | | | | | |
| Image formation treatment, initial | | | | | |
| stage | | | | | |
| Image density ID | 1.254 | 1.412 | 1.421 | 1.409 | 1.401 |
| Evaluation results | Good | Good | Good | Good | Good |
| Fog density FD | 0.001 | 0.002 | 0.001 | 0.002 | 0.001 |
| Evaluation results | Good | Good | Good | Good | Good |
| Charge amount (μC/g) | 24.3 | 15.4 | 17.0 | 14.8 | 16.2 |
| Evaluation results | High | Good | Good | Good | Good |
| Image formation treatment, after | | | | | |
| printing of 30000 copies | | | | | |
| Image density ID | 1.432 | 1.406 | 1.431 | 1.432 | 1.521 |
| Evaluation results | Good | Good | Good | Good | Good |
| Fog density FD | 0.001 | 0.003 | 0.002 | 0.003 | 0.011 |
| Evaluation results | Good | Good | Good | Good | High |
| Charge amount (μC/g) | 16.1 | 16.9 | 17.0 | 14.6 | 9.7 |
| Evaluation results | Good | Good | Good | Good | Low |

TABLE 8

| | Comparative | Examples | | | Comparative |
|---|---|---|---|---|---|
| | Example 15 | 13 | 14 | 15 | Example 16 |
| Kind of coat layer | F | F | F | F | F |
| Porosity of carrier body (%) | 10 | 10 | 10 | 10 | 10 |
| Amount of the silica adhered | 0.8 | 1.0 | 5.0 | 10.0 | 12.0 |
| (Parts by weight) | | | | | |
| Image formation treatment, initial | | | | | |
| stage | | | | | |
| Image density ID | 1.233 | 1.411 | 1.409 | 1.431 | 1.409 |
| Evaluation results | Good | Good | Good | Good | Good |
| Fog density FD | 0.001 | 0.002 | 0.005 | 0.003 | 0.001 |
| Evaluation results | Good | Good | Good | Good | Good |
| Charge amount (μC/g) | 25.3 | 15.9 | 18.1 | 14.6 | 16.8 |
| Evaluation results | High | Good | Good | Good | Good |
| Image formation treatment, after | | | | | |
| printing of 30000 copies | | | | | |
| Image density ID | 1.423 | 1.411 | 1.423 | 1.429 | 1.542 |
| Evaluation results | Good | Good | Good | Good | Good |
| Fog density FD | 0.002 | 0.002 | 0.004 | 0.003 | 0.013 |
| Evaluation results | Good | Good | Good | Good | High |
| Charge amount (μC/g) | 16.5 | 16.2 | 18.1 | 14.5 | 9.5 |
| Evaluation results | Good | Good | Good | Good | Low |

TABLE 9

| | Comparative | Examples | | | Comparative |
|---|---|---|---|---|---|
| | Example 17 | 16 | 17 | 18 | Example 18 |
| Kind of coat layer | F | F | F | F | F |
| Porosity of carrier body (%) | 25 | 25 | 25 | 25 | 25 |
| Amount of the silica adhered | 0.8 | 1.0 | 5.0 | 10.0 | 12.0 |
| (Parts by weight) | | | | | |
| Image formation treatment, initial | | | | | |
| stage | | | | | |
| Image density ID | 1.268 | 1.398 | 1.408 | 1.408 | 1.422 |
| Evaluation results | Good | Good | Good | Good | Good |
| Fog density FD | 0.001 | 0.001 | 0.003 | 0.004 | 0.001 |
| Evaluation results | Good | Good | Good | Good | Good |
| Charge amount (μC/g) | 24.3 | 17.8 | 16.9 | 17.4 | 18.7 |
| Evaluation results | High | Good | Good | Good | Good |
| Image formation treatment, after | | | | | |
| printing of 30000 copies | | | | | |
| Image density ID | 1.432 | 1.396 | 1.409 | 1.409 | 1.555 |
| Evaluation results | Good | Good | Good | Good | Good |
| Fog density FD | 0.002 | 0.001 | 0.002 | 0.001 | 0.016 |
| Evaluation results | Good | Good | Good | Good | High |
| Charge amount (μC/g) | 16.7 | 17.6 | 17.2 | 15.1 | 23.2 |
| Evaluation results | Good | Good | Good | Good | High |

TABLE 10

| | Comparative | Examples | | | Comparative |
|---|---|---|---|---|---|
| | Example 19 | 10 | 13 | 16 | Example 20 |
| Kind of coat layer | F | F | F | F | F |
| Porosity of carrier body (%) | 3 | 5 | 10 | 25 | 30 |
| Amount of the silica adhered | 1.0 | 1.0 | 1.0 | 1.0 | 1.0 |
| (Parts by weight) | | | | | |
| Image formation treatment, initial | | | | | |
| stage | | | | | |
| Image density ID | 1.411 | 1.412 | 1.411 | 1.398 | 1.422 |
| Evaluation results | Good | Good | Good | Good | Good |
| Fog density FD | 0.002 | 0.002 | 0.002 | 0.001 | 0.001 |
| Evaluation results | Good | Good | Good | Good | Good |
| Charge amount (μC/g) | 16.5 | 15.4 | 15.9 | 17.8 | 16.2 |
| Evaluation results | Good | Good | Good | Good | Good |
| Image formation treatment, after | | | | | |
| printing of 30000 copies | | | | | |
| Image density ID | 1.589 | 1.406 | 1.411 | 1.396 | 1.122 |
| Evaluation results | Good | Good | Good | Good | Low |
| Fog density FD | 0.015 | 0.003 | 0.002 | 0.001 | 0.001 |
| Evaluation results | High | Good | Good | Good | Good |
| Charge amount (μC/g) | 9.1 | 16.9 | 16.2 | 17.6 | 23.9 |
| Evaluation results | Low | Good | Good | Good | High |

TABLE 11

| | Comparative | | | | Comparative |
|---|---|---|---|---|---|
| | Example | Examples | | | Example |
| | 21 | 11 | 14 | 17 | 22 |
| Kind of coat layer | F | F | F | F | F |
| Porosity of carrier body (%) | 3 | 5 | 10 | 25 | 30 |
| Amount of the silica adhered | 5.0 | 5.0 | 5.0 | 5.0 | 5.0 |
| (Parts by weight) | | | | | |
| Image formation treatment, initial | | | | | |
| stage | | | | | |
| Image density ID | 1.423 | 1.421 | 1.409 | 1.408 | 1.411 |
| Evaluation results | Good | Good | Good | Good | Good |
| Fog density FD | 0.002 | 0.001 | 0.005 | 0.003 | 0.002 |
| Evaluation results | Good | Good | Good | Good | Good |
| Charge amount (μC/g) | 18.4 | 17.0 | 18.1 | 16.9 | 15.9 |
| Evaluation results | Good | Good | Good | Good | Good |
| Image formation treatment, after | | | | | |
| printing of 30000 copies | | | | | |
| Image density ID | 1.566 | 1.431 | 1.423 | 1.409 | 1.233 |
| Evaluation results | Good | Good | Good | Good | Good |
| Fog density FD | 0.016 | 0.002 | 0.004 | 0.002 | 0.003 |
| Evaluation results | High | Good | Good | Good | Good |
| Charge amount (μC/g) | 8.6 | 17.0 | 18.1 | 17.2 | 23.8 |
| Evaluation results | Low | Good | Good | Good | High |

TABLE 12

| | Comparative | | | | Comparative |
|---|---|---|---|---|---|
| | Example | Examples | | | Example |
| | 23 | 12 | 15 | 18 | 24 |
| Kind of coat layer | F | F | F | F | F |
| Porosity of carrier body (%) | 3 | 5 | 10 | 25 | 30 |
| Amount of the silica adhered | 10.0 | 10.0 | 10.0 | 10.0 | 10.0 |
| (Parts by weight) | | | | | |
| Image formation treatment, initial | | | | | |
| stage | | | | | |
| Image density ID | 1.422 | 1.409 | 1.431 | 1.408 | 1.432 |
| Evaluation results | Good | Good | Good | Good | Good |
| Fog density FD | 0.003 | 0.002 | 0.003 | 0.004 | 0.002 |
| Evaluation results | Good | Good | Good | Good | Good |
| Charge amount (μC/g) | 16.9 | 14.8 | 14.6 | 17.4 | 16.9 |
| Evaluation results | Good | Good | Good | Good | Good |
| Image formation treatment, after | | | | | |
| printing of 30000 copies | | | | | |
| Image density ID | 1.566 | 1.432 | 1.429 | 1.409 | 1.133 |
| Evaluation results | Good | Good | Good | Good | Low |
| Fog density FD | 0.013 | 0.003 | 0.003 | 0.001 | 0.002 |
| Evaluation results | High | Good | Good | Good | Good |
| Charge amount (μC/g) | 8.7 | 14.6 | 14.5 | 15.1 | 24.6 |
| Evaluation results | Low | Good | Good | Good | High |

In Tables 7 to 12, “F” in the column of the “kind of coat resin” means a fluororesin. “Amount of the silica adhered” means the amount adhered (parts by weight) based on 1000 parts by weight of the carrier body.

As is apparent from Tables 7 to 12, Examples 10 to 18 using a carrier body coated with silica adhered having a porosity of 5 to 25%, the amount of the silica adhered being from 1 to 10 parts by weight based on 1000 parts by weight of the carrier body could adjust the results of the image density, fog density and charge amount could be adjusted within a proper range even after repetition of printing 30,000 copies in the image forming treatment.

While preferred embodiments of the invention have been described and illustrated above, it should be understood that these are exemplary of the invention and are not to be considered as limiting. Various modifications of detail to the present invention will be apparent to those skilled in the art of the invention, all of which would come within its spirit and scope.

1. A two-component developer comprising a carrier and a toner, wherein
the carrier contains a carrier body of which surface is porous and uneven and a silica adhered onto the surface of the carrier body,
a porosity of the carrier body is 5 to 25%, and
an amount of the silica adhered onto the surface of the carrier body is from 1 to 10 parts by weight based on 1000 parts by weight of the carrier body.

2. The two-component developer according to claim 1, wherein the carrier body comprises a core particle of which surface is porous and uneven and a coat layer formed on the surface of the core particle.

3. The two-component developer according to claim 1, wherein the carrier is adjusted by mixing the carrier body of which surface is porous and uneven and a porosity of 5 to 25% with the silica in a mixer and stirring a resulting mixture in a mill to have an amount of the silica adhered on to the surface of the carrier body within a range from 1 to 10 parts by weight based on 1000 parts by weight of the carrier body.

4. The two-component developer according to claim 1, wherein the carrier body has a primary particle size of 30 to 100 μm.

5. The two-component developer according to claim 1, wherein the silica has a primary particle size of 0.1 to 100 nm.

6. The two-component developer according to claim 2, wherein the coat layer is a silicone resin layer.

7. The two-component developer according to claim 2, wherein the coat layer is a fluororesin layer.
